(19) United States
(12) Patent Application Publication
(10) Pub. No.: US 2008/0205251 A1
(43) Pub. Date: Aug. 28, 2008

(54) Method and System For Data Recording and Reading in Multi-Photon Excitable Media

(76) Inventors: Ortal Alpert, Jerusalem (IL); Yair Salomon, Jerusalem (IL); Andrew N. Shipway, Jerusalem (IL)

Correspondence Address: BROWDY AND NEIMARK, P.L.L.C.;624 NINTH STREET, NW, SUITE 300, WASHINGTON, DC, 20001-5303, US

(21) Appl. No.: 11/994,974

(22) PCT Filed: Jul. 6, 2006
(86) PCT No.: PCT/IL06/00788

§ 371 Date: Jan. 7, 2008

Related U.S. Application Data
(60) Provisional application No. 60/696,810, filed on Jul. 7, 2005.

(51) Int. Cl. G11B 7/004

(52) U.S. Cl. 369/125

(57) ABSTRACT

A method, system and non-linear optical storage medium are presented for use in at least reading data in the medium. The technique utilizes a first function corresponding to an effect of data recording in the medium and a second function corresponding to an effect of reading the recorded data, where each of the first and second functions is a function of at least a power profile of applied interacting radiation in a respective one of the recording and reading events and a duration of said event. These data is utilized to select a certain operating mode defined by ranges of said power and duration parameters during the reading process corresponding to a non-degenerate relation between the first and second functions.

### FIELD OF THE INVENTION

This invention is generally in the field of recording/reading data in information carriers, and relates to a recording and reading method and system for use with a non-linear three dimensional optical information carrier.

### BACKGROUND OF THE INVENTION

Patent Convention Treaty Publication WO 01/73779, assigned to the assignee of the present application, discloses a non-linear three dimensional information carrier having a monolithic disc-like body made of a transparent or translucent polymer material with an active moiety bond thereto. The active moiety (chromophore) is responsive to laser radiation and it changes its state from one isomeric form to another upon interaction with laser energy. The active moiety exhibits multi-photon absorption. The information is recorded on such a carrier as a series of regular or oblong and/or tilted data marks. This technique is disclosed in Patent Convention Treaty Publication WO 2005/015552, assigned to the assignee of the present application. Each record of the mark represents a channel symbol. The marks may be three dimensional (3D) marks.

The two-photon media, as disclosed in the article “Effect of saturable response to two-photon absorption on the readout signal level of three dimensional bit optical data storage in a photo chromatic polymer”, Min Gu et al., Applied Physics Letters, Volume 79, No. 2 pp 148-150, 2001, is typically recorded by a burst of femto second pulses. Each burst contains a large number of ultra short femto second pulses that have a duration of about 80 femto seconds.

Two-photon media is an example of 3D non-linear media, e.g. U.S. Pat. No. 6,608,774, or for higher order interaction, e.g. a four wave mixing process, as disclosed in WO 03/077240 assigned to the assignee of the present application. A non-linear optical medium is a medium in which at least one of the recording/erasing and reading processes is non-linear, with non-linearity preferably higher than χ(2) (chi) interaction process. The non-linearity may also arise from a step wise process, e.g. a 1+1 recording process as described in U.S. Pat. No. 6,846,434.

Also known in the art is a combination of 1-photon and multi-photon processes where one of the recording or reading processes is performed by a 1-photon excitation process and the other process is non-linear (multi-photon excitation).

### SUMMARY OF THE INVENTION

The problems solved by the present invention are associated with the difficulty of recording readable information in a non-linear optical storage medium, and with the fact that in some cases a reading process performs to a certain extent the effect of recording or what is called graying.

There is a need in the art for a proper recording strategy that would improve the recording process performance and positively affect the reading process. Also, there is a need for a proper reading strategy that would eliminate or at least significantly reduce the undesired effect of graying in the medium and thus support a large number of reading cycles.

A medium used in the present invention is a non-linear optical medium. As indicated above, a non-linear optical medium is a medium in which at least one of the data recording/erasing and reading processes is non-linear (non-linearity of χ(2) (chi) or higher order interaction process). Such a medium is excitable by recording radiation (e.g. by multi-photon radiation) to cause a local change of the medium properties (e.g. isomerization of chromophores) within the excited region, thereby creating a stable recorded region surrounded by unrecorded spaces, and is then excitable by, or interacting with, reading radiation (e.g. multi-photon radiation) to provide a response from the recorded region different from that of the unrecorded spaces.

It should be understood that the data recording or erasing process is aimed at affecting (creating or removing, respectively) the depth or level of modulation in the medium, while the data reading process is aimed at substantially not affecting the depth of modulation. Hence, it should be understood that when speaking about the process parameters for recording, actually recording or erasing process is considered.

In the context of the present disclosure, the depth or level of modulation corresponds to the contrast ratio of the recorded region (mark) as compared to the unrecorded spaces. This can be determined as (1−Iₘᵢₙ/Iₘₐₓ) where Iₘₐₓ and Iₘᵢₙ are the maximal and the minimal levels of the signal (e.g. fluorescence) from the recorded region and a unrecorded space. It should however be noted that any other known suitable contrast ratio definitions may be applicable.

A non-linear medium is sometimes referred to herein as “two-photon medium”, but it should be understood that the present invention is not limited to this type of media.

Processes of recording and reading of information in such a non-linear medium (e.g. two-photon medium) require accurate and repeatable process conditions. The recording and reading processes depend inter alia on the power delivered to each mark or voxel, the duration and shape of the reading/recording event, as well as polarization, coherence and wavelength of light used. If one or more of these parameters does not match the required range of values, this affects (reduces) the quality of the data recording/reading process.

It should be understood that according to the invention, duration of a recording event or duration of a reading event signifies the duration of a single pulse or the total duration (envelope) of burst of pulses. Here, burst of pulses signifies a sequence of pulses with appropriately selected individual pulse duration and pulse separation interval. These parameters are defined inter alia by a desired heat transfer to the addressed region in the medium and/or the lifetime of excited states and/or and an isomerization rate. For example, the burst of pulses is selected to ensure that the heat dissipation during the time interval between said pulses will be insubstantial. Typically, the time interval between consecutive pulses within a burst does not exceed 10 nsec and is dependent on various parameters of the medium and process applied thereto, such as rotation speed, fluorescence life time, required temperature range and required modulation depth. These parameters may be coupled.

In some instances, the recording function may be distributed between an activating beam, that heats the voxel to be recorded and a recording beam that performs the actual recording. As disclosed in PCT/IL2006/00051 and PCT/IL2006/00050, both assigned to the assignee of the present application, heat typically assists the recording of a multi-photon medium.

A process of reading information recorded in a non-linear media involves interrogation of a recorded mark or region or voxel with appropriate power and wavelength. The interrogated voxel responds, for example, by fluorescence or Raman scattering which is detected and interpreted. Recorded information in a non-linear medium, and in particular two-photon medium, typically exhibits low contrast of the recorded information, low signal and, consequently, significant background noise. Accordingly, it is desired to increase the signal-to-noise ratio of the reading process at least to an operative value and to keep it above a certain threshold. Reading information from a two-photon storage medium with higher laser energy (to increase the signal) may cause graying and thus further decrease the signal to noise ratio. A three-dimensional storage medium should sustain, however, a large number of reading cycles without graying. Such parameters as coherence and polarization of exciting light may also affect the reading and recording processes and be utilized to differentiate between these processes and to control the effect of graying.

The present invention solves the above problems by appropriately utilizing data indicative of a function corresponding to an effect of recording in the medium used and a function corresponding to the effect of reading the recorded data (i.e. the medium response to a reading radiation), where each of these functions is a function of at least one of such parameters as a temporal profile of power of exciting radiation (or generally, interacting radiation) within the respective one of the recording and reading events, and the event duration. According to the invention, this data is utilized to select a certain operating regime or mode, namely an operating value (or range of values) for at least one of the above parameters during the reading process. The selected operating regime is such as to provide a non-degenerate relation between said functions. This allows for controlling the effect of recording during the reading process (henceforth “graying”).

The effect of recording in the medium is defined by recording efficiency (or sometimes termed relative recording) which corresponds to the extent of recording to the required depth or level of modulation.

The term mode or regime in the context of the present disclosure means a defined (and constrained) multi-dimensional combination of process parameters. As indicated above, these parameters include temporal power profile (or shape) and duration of the respective irradiation event. It should be noted that the operating regime is selected for a given condition of at least one of wavelength, coherence and polarization of the applied radiation.

A condition of non-degenerate relation between the above two functions means that there exist at least one range of at least one of the above parameters within which one function cannot be completely determined by the other, but at least one free for control parameter exists.

In the present invention, a non-degenerate relation between the first function corresponding to the effect of recording in the medium and the second function corresponding to the effect of reading the recorded radiation (i.e. medium response to the reading radiation) is utilized to provide a predetermined ratio between the maximal allowed effect of recording during the reading event to an effect of recording achieved while recording the data being read.

There is thus provided according to one broad aspect of the invention a method for use in at least reading data in a non-linear optical storage medium, the method comprising: utilizing a first function corresponding to an effect of data recording in said medium and a second function corresponding to an effect of reading the recorded data, each of the first and second functions being a function of at least a power profile of applied interacting radiation within a respective one of the recording and reading events and a duration of said event, and selecting a certain operating mode defined by ranges of said parameters during the reading process, said selected operating mode corresponding to a non-degenerate relation between said first and second functions.

As indicated above, the effect of recording is determined by the depth of modulation, and the effect of reading is determined by the medium response to a reading signal.

Preferably, the operating mode (i.e. the ranges of the power and duration parameters) is selected for a given condition of at least one of the following: wavelength, coherence and polarization of the applied interacting radiation.

Preferably, the non-degenerate relation is utilized to provide a predetermined ratio between the maximal allowed effect of data recording during the reading event to an effect of recording achieved while recording the data being read. This ratio is non-degenerate such that there is at least one parameter to control graying, and preferably the sensitivity of that parameter in terms of functional dependence is higher than the square root of that parameter

The method utilizes appropriate selection of the function corresponding to the power profile during the reading event.

The invention preferably utilizes signal emission (medium response) in a range of 400-600 nm, thus allowing the reading and recording processes carried out with the same wavelength range of the interacting radiation, this wavelength range is preferably 600-800 nm. Generally, the invention preferably operates with wavelengths of red-NIR spectral range for both recording and reading processes. The recording and reading wavelengths may be close to each other, with a difference between them not exceeding 300 nm.

The invention preferably utilizes relatively long recording events (at least one nanosecond, e.g. about a few tens of nanoseconds) and relatively short reading events. The long recording event may be represented by a single long pulse, or by a burst of pulses with a long envelope of the burst (at least one nanosecond duration). The energy peak of the interacting radiation during the recording is preferably at least two times higher than the energy peak of the interacting radiation during the reading event.

The first and second functions may be respectively W=C₁·P^{m1}·tⁿ¹ and S=C₂·P^{m2}·tⁿ², wherein P is peak power, t is event duration, C₁ and C₂ are certain coefficients, m₁, n₁, m₂ and n₂ are dominant powers selected to satisfy the condition that m₁/m₂≠n₁/n₂. For example, the first and second functions may be W=C₁·P^{1.5}·t^{2.5} and S=C₂·P^{1.5}·t, the controlling of graying thus including selection of the duration of the reading event; or W=C₁·P⁴·t³ and S=C₂ P²·t, the controlling of graying including selection of at least one of the power and duration of the reading event.

According to another broad aspect of the invention, there is provided a method for use in recording data in a non-linear optical storage medium, the method comprising: recording a data mark in the medium by applying thereto an interacting radiation for at least one nanosecond.

According to yet another broad aspect of the present invention, there is provided a non-linear optical storage medium characterized by a first function corresponding to an effect of data recording in the medium and a second function corresponding to an effect of reading the recorded data, each of the first and second functions being a function of at least a power profile of applied interacting radiation during the respective one of the recording and reading events and a duration of said event, such that there exist certain ranges of said power and duration for the reading process corresponding to a non-degenerate relation between said first and second functions.

According to yet further aspect of the invention, there is provided an illumination system for producing predetermined interacting radiation for use in at least one of data reading and recording processes on a non-linear optical storage medium, the system comprising:

(a) a light source unit configured for generating interacting radiation; and

(b) a control unit for operating the light source unit with selected values of a power profile of the interacting radiation during at least one of the reading and recording events and a duration of the respective event, to thereby produce said predetermined interacting radiation, said values being within ranges providing sufficient reading and recording and corresponding to a non-degenerate relation between a first function corresponding to an effect of recording in the medium used and a second function corresponding to said medium response to a reading signal, each of the first and second functions being a function of the power of exposure and the duration of the respective one of the recording and reading events; the system thereby enabling controlling of the effect of recording during the reading process.

It should be understood that sufficient reading and recording signifies achievement of a required depth of modulation while recording and achievement of a strong enough response signal from the medium while reading the recorded data.

In yet another aspect of the invention, there is provided a system for performing at least one of reading and recording of optically storable information, the system comprising:

(a) an optical information carrier formed by a non-linear optical storage medium configured to be characterized by a first function corresponding to an effect of recording therein and a second function corresponding to an effect of reading the recorded data, each of the first and second functions being a function of at least a power profile of applied interacting radiation during the respective one of the recording and reading events and a duration of said event, such that there exist values of the power and duration for the reading process within ranges corresponding to a non-degenerate relation between said first and second functions

(b) a light source unit configured and operable for generating interacting radiation for at least one of the reading and recording processes using said values of the power and duration.

The invention also provides an optical memory reading device comprising:

(a) a light source unit configured for generating interacting radiation to be applied to a non-linear optical medium to cause a readable response therefrom; and

(b) a driver for operating the light source unit with selected values of a power of the interacting radiation during a reading event and a duration of the respective event, said values being within ranges corresponding to a non-degenerate relation between a first function corresponding to an effect of recording in the medium used and a second function corresponding to an effect of data reading, each of the first and second functions being a function of at least the power of the interacting radiation and the duration of the respective one of the recording and reading events.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A exemplifies a flow chart of a method according to the invention for use in data reading from a non-linear optical storage medium;

FIG. 1B exemplifies a system of the present invention for use in data recording and/or reading on a non-linear optical storage medium;

FIGS. 2A and 2B are schematic illustrations of a recording pulse and fluorescence level of information marks recorded by the pulse;

FIG. 3 is a graph of the changes in the modulation depth as a result of repeated medium interrogation (irradiation);

FIG. 4 is a graph of the relative recording efficiency as a function of pulse length;

FIG. 5 is a graph of the relative recording per pulse as a function of product (PP⁴·PD³), where PP is a peak power and PD is the pulse length;

FIGS. 6A to 6D illustrate different shapes of the single recording pulse suitable to be used in the present invention;

FIG. 7 exemplifies the variation of the medium response signal during multiple reading cycles applied to the same region in the medium, thereby presenting a graying curve; and

FIG. 8 exemplifies a two-photon absorbance spectrum of the specific medium.

### DETAILED DESCRIPTION OF EXEMPLARY EMBODIMENTS

The present invention, in some of its aspects, provides for optimizing the processes of recording and reading information in a 3D non-linear optical medium, in particular in a two-photon medium. In some embodiments of the present invention, it provides a proper recording and reading strategy by appropriate control of the recording and reading regime, namely the process parameters, such as for example power profile during the recording and reading events and the duration of the event. Selecting the proper reading regime may be aimed at minimizing the graying (the effect of recording during a reading process).

A non-linear optical storage medium used in the present invention is characterized by a certain first function W corresponding to a desired effect of recording (i.e. providing desired depth of modulation within the medium or recorded region) and a certain second function S corresponding to a detectable light response of the recorded region to a reading signal. These first and second functions are such that there exists a certain operating reading regime that corresponds to a non-degenerate relation between the first and second functions. This allows for controlling the effect of recording in the medium during the reading process (i.e. graying).

The multi-photon medium may be that described in the above-indicated Patent Convention Treaty Publication WO 01/73779, as well as those of PCT/IL2006/00051 and PCT/IL2006/00050, all assigned to the assignee of the present application. However, it should be understood that the invention is not limited to these specific examples, and the invented method of controlled graying is applicable to any 3D non-linear optical media in general.

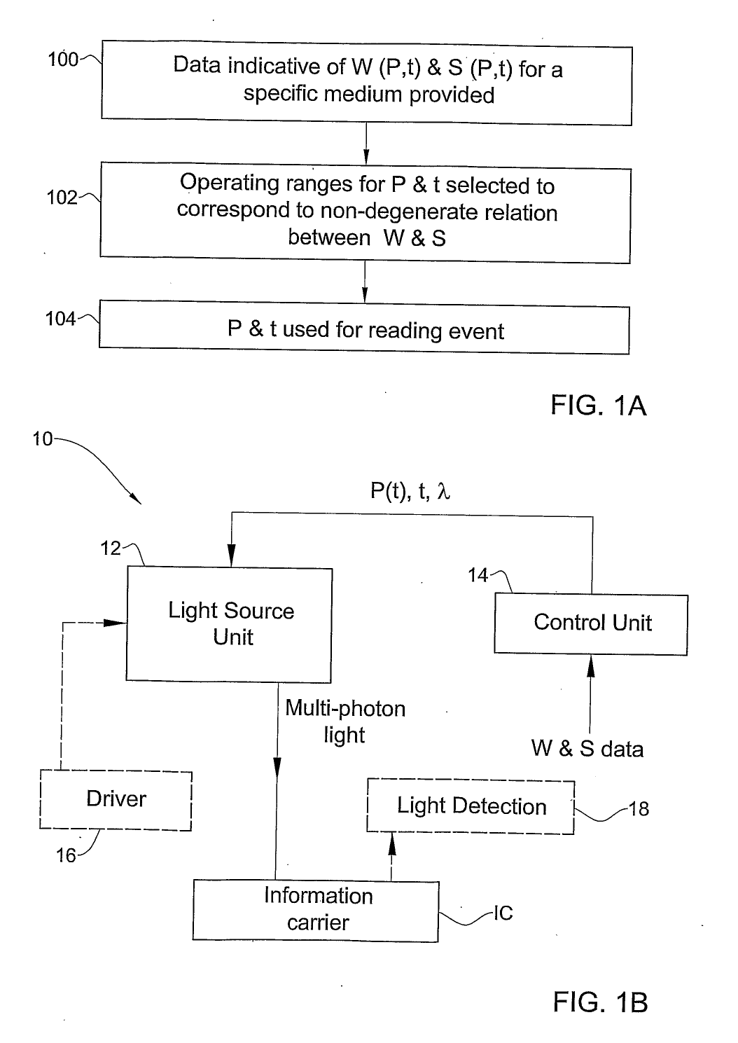

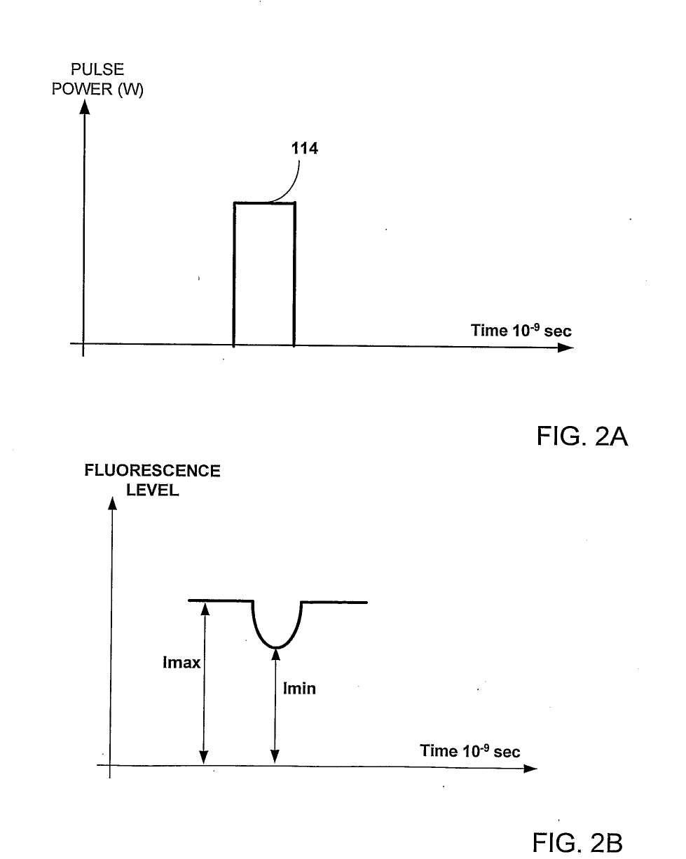

Reference is made to FIG. 1A exemplifying a data reading method of the present invention. As shown, data indicative of the first and second functions W(P,t) and S(P,t) of the specific medium in an information carrier used are provided (step 100). These data are utilized to select certain operating values of the reading power P(t) and duration t of the reading event providing a non-degenerate relation between the first and second functions (step 102). The selected power and duration ranges are then used for controlling the reading process (step 104) and effect of graying caused by this process.

FIG. 1B exemplifies a system, generally designated 10, of the present invention for use in data recording and/or reading in a non-linear optical storage medium of an information carrier. System 10 is configured to enable effective control of an effect of graying during the data reading process. System 10 includes a light source unit 12 (typically a laser based unit) configured for generating exciting/interacting radiation (e.g. multi-photon radiation); and a control unit 14 configured for operating the light source unit with selected values of process parameters, such as a power of exposure and event duration during the reading process (for given operating wavelength(s) and/or coherence and/or polarization of light from the light source unit), to thereby produce the interacting radiation of the desired regime. System 10 may also include a drive unit 16 associated with the light source unit, and may or may not include as its constructional part a light detector 18 for reading the light response of the medium.

The power and duration values are selected based on data about the non-linear optical medium used in the information carrier, namely a first function corresponding to an effect of recording in the medium used and a second function corresponding to said medium response to a reading signal, where each of the first and second functions is a function of the power and event duration. The selected values of the process parameters are within ranges corresponding to a non-degenerate relation between the first and second functions.

The present invention is based on the understanding of the following particulars and requirements of the recording/reading conditions.

A recording process involves essentially two processes: (1) insertion of energy into an intended recording volume/voxel, and (2) formation, by the introduced energy, of changes in the photochromic state of the voxel being recorded such that it can be later detected by the reading process.

An effective reading process requires reduction of the yield of the recording process and direction of absorbed energy into the states of the matrix/moiety that are not coupled with the recording process. Practically, it would be an ability of reading the recorded medium with sufficient reading signal power and modulation depth for more than 10 times (preferably more than 100 times, and more preferably more than 1000 times, and even more than 10,000 times). In other words, the reading process should not cause graying of the medium, or at least significantly reduce the graying, thereby enabling multiple cycles of effective reading.

In two-photon (2P) media (i.e., media excitable by 2P process for recording, and/or excitable by 2P process for reading in the recorded region), graying is a process associated with the related similarity of the two processes. The effect of graying reduces the contrast between recorded marks and non-recorded spaces (depth of modulation). Generally, the amount of graying is a function of the radiation wavelength, coherence and polarization, radiation pulse shape (temporal profile) and duration.

Hence, the performance of the reading and recording processes can be controlled by controlling at least one of such process parameters as wavelength, coherence and polarization, power profile and duration of the reading/recording event. Although, complex feedback such as one caused by heating of the interrogated location in the media may further complicate the data recording or retrieving processes.

Three dimensional non-linear optical storage medium provides for storing therein substantially larger quantity of data than that of the conventional optical discs. Subsequently to process larger data quantities users require reading or recording on such a non-linear optical storage medium at high transfer rates. Means enabling these high transfer rates and high storage capacity include inter alia the size of recorded marks. Small recorded marks require use of optics with high numerical aperture (typically NA>0.5) capable of focusing laser radiation into a diffraction limited spot.

More specifically, with regard to selection of recording and reading wavelengths, the following should be noted:

In order to accomplish a reasonable storage density (higher then 30 MB/cm² per layer), the size of written data marks must be appropriately small. This limits the range of wavelengths of light that may be used to address a medium, since the minimum spot size on which laser light may be focused depends linearly on its wavelength. In order to achieve said storage density, a wavelength of less than 900 nm is required, although wavelengths as long as 1064 nm are known to be used (medium response is in the red region of the spectrum), and smaller wavelengths are more preferred.

In addition to this constraint, short wavelengths of light may not be used for excitation since they are linearly absorbed by the medium and therefore cannot easily reach lower layers, and cause excitation in all the layers of the information carrier, without sufficiently high 3D resolution. Polymers commonly used for optical information carriers (acrylates, polycarbonates) absorb wavelengths up to about 300 nm, and data storage chromophores absorb at longer wavelengths. Therefore, only a spectral region of 400-900 nm is available for the reading and writing of dense data, and this wavelength range has to include the absorbance bands utilized for reading and writing as well as the emission band of the signal (medium response).

Since the emission band is necessarily close to the linear absorbance band that relates to it, this band should be in the region of 400-600 nm, longer wavelengths would prohibit the use of red spectral range for the interacting radiation. This wavelength range of the response signal is preferred also to allow the usage of shorter (closer to 600 nm) wavelengths for the recording/reading, because it allows higher flux in the same diode power, which is important for the non-linear interaction. Interaction or interrogation wavelengths shorter than 400 nm are less favored for excitation since they represent larger excitation energies, which are more likely to cause chemical damage in the medium. Given that in the solid state absorbance and emission bands are broad, especially for multi-photon process, it is therefore very unlikely that a non-linear optical storage medium can be developed where the reading and writing processes are each excited by different wavelengths of light which do not interfere with each other (e.g. by a reading beam causing slight excitation of a writing band).

Usage of ultrashort pulses, i.e. pulses of up to a few picoseconds, also limits the use of the available wavelength range. This is because ultrashort pulses having large band width decrease the possibility of separating absorption or interaction bands.

It should also be noted that unintentional excitation is not the only way that a system attempting to use different absorbance bands for reading and writing photochemistry is likely to fail in the complete energetic separation of the processes. It is also highly probable that any system that has two such similar excited states will suffer from some spontaneous energy transfer between those states.

It thus becomes clear that means for differentiating between the “reading” and “recording” photochemical processes other than wavelength alone are necessary in order to create a working 3D media, while wavelength may be used as part of the differentiation.

The technique of the present invention provides for achieving the controlled graying even when the reading and recording wavelengths are the same or close to each other, such that the difference in wavelengths used in the recording and reading is less than 300 nm, and the recording/reading processes are coupled. Wide spectral peaks are typical for two photon absorption spectra materials and for higher order processes. The overlap between the peaks indicates that excited chromophores may easily switch between excited states that lead to data recording and excited states that lead to data reading (retrieving). Ways to control the processes include provision of sufficient energy difference between the reading and recording processes. This may be achieved by regulating the irradiation power magnitude during the pulse (i.e. power profile) and/or pulse duration. The invention provides for efficiently implementing this process.

With regard to the power of exciting radiation, the following should be noted. The read out luminescence signal level is of importance for reliable media reading. However, simple increase in the exciting optical energy (power) during the reading process to achieve the desired signal level (light response) might, results in greater amount of graying caused by the reading beam. Thus, on the one hand, if the signal level is not high enough, the system performance will be degraded, and on the other hand, higher than required exposure by reading radiation would cause excessive graying, especially in non-recorded media regions.

By appropriately utilizing data indicative of the reading process it is in some cases convenient to express the amount of recording power W in the following general polynomial expression, where Pp are the peak power levels and t is the pulse (event) duration:

W=A₁Pₚt+A₂Pₚ²t+A₃Pₚ³t+ . . .

The equations should be understood as “integral” of equations summarizing the effect of the pulse within the pulse duration. In should be noted that in practice the pulse power is varying in time, i.e. has a certain profile during the pulse (event). In practical situations, the pulse duration is sometimes defined by FWHM (Full Width at Half Maximum), which for many pulse types describes the result of the pulse integration.

However, at every power level range, there is usually only one dominant term in the equation. Hence, generally the effect of recording in the medium can be approximated by:

W=C₁P^{m}^{₁}tⁿ^{₁} (1)

where W is the first function corresponding to the effect of recording produced by the applied optical power P within the duration t of the recording event, C₁ is a constant, and m₁ and n₁ are dominant powers.

The process of characterizing the recording functional within a certain regime is not restricted to the use of polynomial functions and may result in an approximation or a bound on the functional behavior that is similar in form to equation (1) but the coefficients may not necessarily be natural numbers.

By appropriately utilizing data/information indicative of the reading process, the effect of reading, namely amount of signal (light response) generated by the reading event, can in some cases be characterized in a similar manner by a polynomial expression:

S=C₂P^{m}^{₂}tⁿ^{₂} (2)

where S is the second function corresponding to the medium response to the reading radiation, and C₂ is a constant.

Signal S is typically a fluorescence signal, and can thus be described for 2P medium reading at low excitation levels (i.e. no saturation of the excited state) by the expression:

S=C₂P²t (3)

The inventors have found that a non-degenerate relationship between the first function W corresponding to the effect of data recording and the second function S corresponding to the effect of data reading enables graying control. In order to establish proper control parameters, the behavior or relation of the graying (recording) caused by the reading mode is of particular interest. The non-degenerate relationship provides for the process control as this relationship ensures at least one free for control parameter.

For example, considering the first and second functions as respectively W=C₁·P^{m1}·tⁿ¹ and S=C₂·P^{m2}·tⁿ², such a non-degenerate relation is provided if the dominant powers m₁, n₁, m₂ and n₂ satisfy the condition m₁/m₂≠n₁/n₂.

In the process of selecting the appropriate parameters (or parameter ranges), the reading effect function S and the recording effect function W are bounded by respective functional dependencies for which a proper mathematical approximation can be worked out.

If the recording function is completely determined by the reading function, i.e. W=ƒ(S), then there is no free parameter to establish the graying control. For example, if the reading function S is faithfully approximated by S≈C₁·P²·t and the recording function by W=C₂·P⁴·t², then

$$W \approx \frac{{C}_{2}}{{C}_{1}^{2}} \cdot {S}^{2} ,$$

and no matter how the parameters of the reading process are modified (for a given reading signal level) the same extent of graying will occur.

Controlled graying could be achieved if there is a method of controlling the degenerate ratio

$$\frac{{C}_{2}}{{C}_{1}^{2}}$$

and transforming the functional ratio into a non-degenerate form, by, for example, an activation process. One such activation process is achieved by the inclusion of dye additive capable of absorbing activation energy as disclosed in the above indicated PCT/IL2006/00051 and PCT/IL2006/00050, both assigned to the assignee of the present application. It should be understood that for a non-linear medium (and multi-photon absorption), the use of separation between the activation process and the reading/recording process may be an alternative to the use of a non-degenerate relation, that comes at the price of additional complexity; e.g. incorporation of additives and the use of a separate activation radiation in a wavelength range that is far enough from the reading/recording wavelengths so that there would be substantially no coupling between the activation and the reading/recording interactions, otherwise reading would activate recording and this is highly undesirable.

Reliable control of graying requires establishing of reliable bounds faithfully (faithfully utilizing the data and possibly performing approximations) reflecting the conditions of reading and recording modes. For example, the use of a Ti-sapphire laser providing femto second or pico second pulses for reading or recording in two-photon media may result in saturation of the two-photon excited state. In such case, the power dependence of light response may be less than quadratic and even sub-linear at very high peak powers, thus the quadratic expression of equation (3) would not be faithful, and to control graying in this operation regime an appropriate expression is to be derived by utilizing a measured response.

If for example the reading function (i.e. light response) and the recording function behave as S=C₁·P^{1.5}·t and W=C₂·P^{1.5}·t^{2.5} respectively, the controlled graying may be supported by control of the pulse (event) duration t, because the functional relationship is not degenerate:

$$W = \frac{{C}_{2}}{{C}_{1}} \cdot S \cdot {t}^{1.5} .$$

However, the way of control only through the process parameter t might be limited by the range of pulse durations available with ultra short pulsed lasers.

Let us consider, an examples of a non-linear medium (disclosed in the above-indicated PCT/IL2006/00051 assigned to the assignee of the present application), comprising 20% in weight of the active chromophore (eMMA) 80 wt % MMA.

More specifically, a disk-like information carrier containing chromophores linked to a poly(acrylate) chain can be made by copolymerizing MMA with a chromophore-containing monomer, e.g. “eMMA” or “eAA” of the following structures:

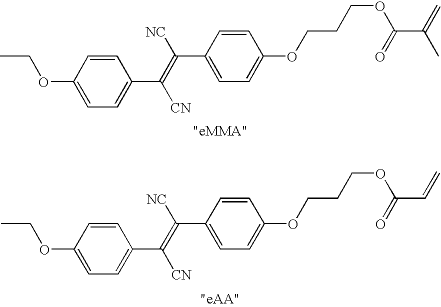

A solution of the chromophore-containing monomer and ˜0.2% AIBN (a radical initiator) in MMA is prepared at 60-65 C, and is put into a mold in the shape of a disk. The mold is lowered into a water bath which is held at 60° C. for 18 hours, after which the mold is cooled and opened to obtain the disk. As a consequence of the solubility limit of eMMA and eAA in MMA, it is not possible to make disks that contain more than ˜20 wt % eMMA or ˜25 wt % eAA.

It should be understood that the invention is not limited to this specific example. Also, it is possible to utilize a medium that contains both eMMA at 10 wt % and eAA at 20 wt %. Thus, by using a mixture of only two chromophore-containing molecules that differ only in a methyl group, it is possible to increase the maximum total chromophore concentration from 25 to 30 wt %.

In the specific examples of using the above media, the reading and recording functions are faithfully characterized by S≈C₁·P²·t and W=C₂·P⁴·t³, which satisfies the requirement of non-degenerate relationship,

$$W = \frac{{C}_{2}}{{C}_{1}^{2}} \cdot {S}^{2} \cdot t ,$$

thus allowing for graying control via both the power P and duration t parameters.

For the purpose of analysis, it should be noted that in some cases the functional relation between the reading and the recording effects could be divided into two parts

$$W = \underbrace{C \cdot f ( S )}_{I} \cdot \underbrace{g ( P , t , … )}_{II} ,$$

where part (I) is the “modulus” and part (II) is the “remainder.” The modulus part dictates the sensitivity of the reading mode to the effect of recording (graying). A small factor C and a low-value function ƒ are preferable. The remainder is a free parameter set that establishes the controllability of graying, which is preferably a high power function g of the free parameters. By convention, the modulus is the smallest power but it should be noted that it is not the only possible representation. Considering the above example of S≈C₁·P²·t and W=C₂·P⁴·t³, the two representations

$$\begin{matrix}W = \frac{{C}_{2}}{{C}_{1}} \cdot S \cdot {P}^{2} \cdot {t}^{2} & and & W =\end{matrix} \frac{{C}_{2}}{{C}_{1}^{2}} \cdot {S}^{2} \cdot t$$

are equivalent. More complex relationships, such as W=S·P²·t²+\sqrt{S·t}, may also exist but are harder to analyze. It should be understood that even if the process of utilizing the data is performed without an explicit parametric expression (e.g. by the use of neural networks), the condition of a non-degenerate relation between the two functions should still exist.

In general, if the first and second functions corresponding to the effects of recording and reading in the medium are characterized by a non-degenerate relation between them, then there is at least one free parameter available for process control to obtain a desired reading/recording regime to reduce the effect of graying.

Given the power and time dependence of the data recording and the data reading processes, use of modulated recording power profiles (e.g. pulses or burst of pulses) may have advantages over the use of rectangular-shaped recording events. As noted in the above-indicated article “Effect of saturable response to two-photon absorption on the readout signal level of three dimensional bit optical data storage in a photo chromatic polymer” by Min Gu et al., Applied Physics Letters, Volume 79, No. 2 pp 148-150, data marks are typically recorded by a burst of femtosecond pulses.

The inventors have found that recording with a relatively long event, for example using a single long pulse (as compared to sub-nano second pulse), of an appropriate power profile during the pulse (event) results in a better quality of recorded information. The term “long pulse” or “long event” means a pulse/event of a duration of at least one nanosecond, for example a few 10s of nanoseconds.

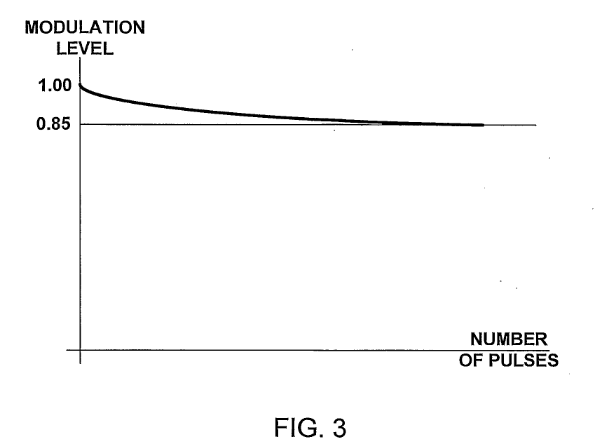

Reference is made to FIGS. 2A and 2B illustrating, respectively, a single recording pulse 114 and the fluorescence level of information marks recorded by single recording pulse 114. Single long pulse 114 may have, for example, duration of about 40 nanoseconds. The level of modulation obtained by the single long pulse is better than that obtainable by a series of temporally spaced-apart by millisecond intervals shorter pulses having the same peak power and the same accumulated duration.

As indicated above, depth or level of modulation may be defined as the contrast ratio of the recorded marks, namely (1−Iₘᵢₙ/Iₘₐₓ) where Iₘₐₓ and Iₘᵢₙ (FIG. 2B) are the maximal and the minimal levels of the signal (e.g fluorescence) from the recorded mark and a non-recorded space (background).

These improved recording results produced, for example, by longer pulses may be characterized by the increased recording efficiency, which may be a function of the laser recording pulse (shape and duration) and one or more other parameters such as the polymer material composition.

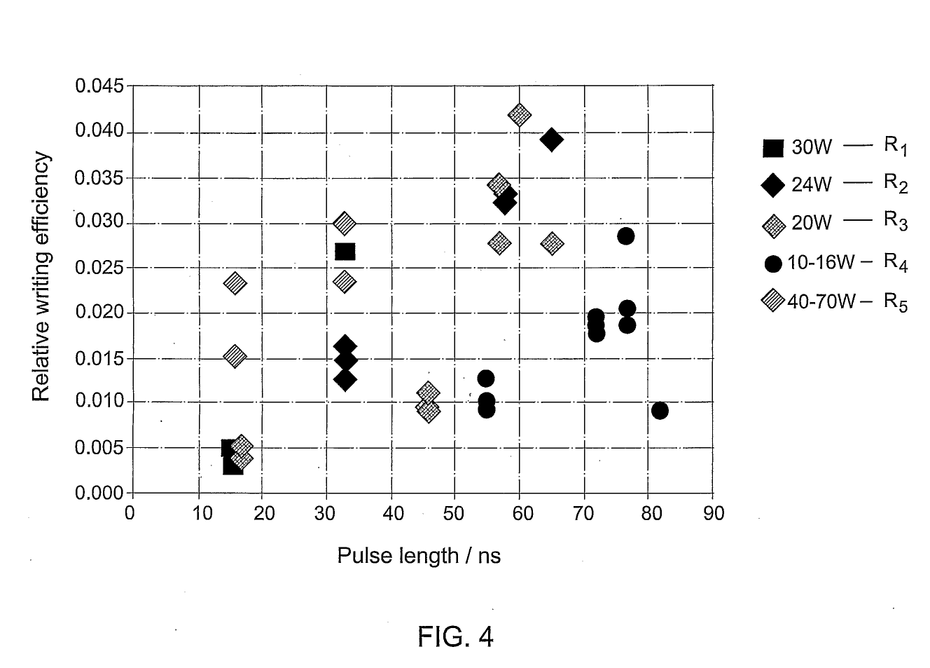

Such characteristics as recording efficiency, and recording efficiency per pulse were empirically estimated by noticing that the modulation depth achieved by repeated medium interrogation (irradiation) decreases towards a base line as an inverse exponential function shown in FIG. 3. The term “recording efficiency per pulse” corresponds to the effect of recording per single pulse in a series of pulses that are temporally spaced apart so that each pulse is practically a separate event. In other words, the term recording efficiency per pulse is to be understood here as recording efficiency per event.

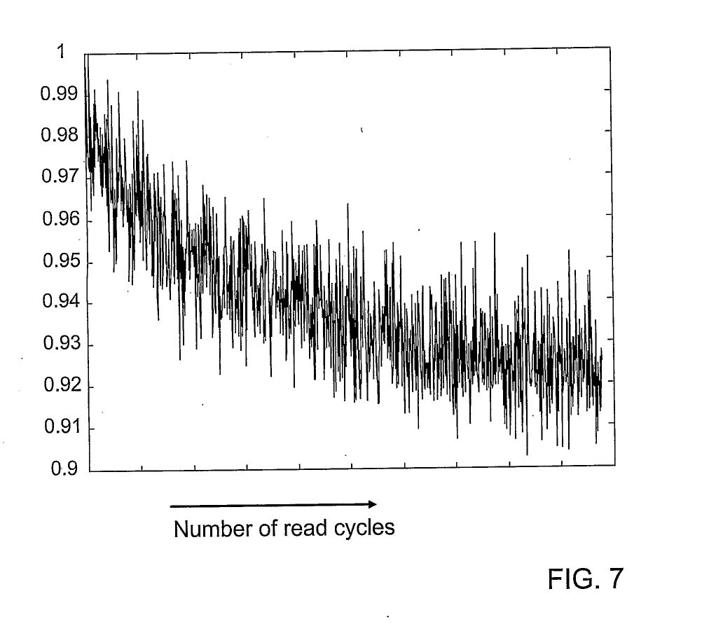

Reference to FIG. 7 is now made to exemplifying a method of characterizing the recording efficiency. The figure describes the use of consecutive pulses to irradiate a region in the medium by a 658 m radiation focused to diffraction limit, during multiple cycles of the reading process. The graph corresponds to the detected effect of reading (i.e. medium response) during the multiple reading cycles. The reading radiation is applied to and read out from a data region represented by an unrecorded space in the medium. As shown, the detected signal (response) decreases with the increase in the number of reading cycles, as a result of the effect of graying, which after many repeated reading cycles effectively records a mark in the medium, thus converting the unrecorded space into the recorded mark. The recording effect of each radiation pulse applied to the medium is seen to decrease as the rate of signal decay decreases. This may be attributed to change in optical and photochemical properties of the position in the medium being read and recorded. For example, if the cross section of the active chromophores that switched is lower, then there is less 2P absorbance within the volume of the mark, the photo-dynamics of the processes within said position also changes as a result of a change in the composition of the active medium within said position.

Recording by consecutive pulses has the same cumulative effect as the recording with stronger or longer single pulse. The recording is indifferent to how it is being performed and in this sense it is memoryless.

It was found that by approximating said decaying recording with a decaying exponential the recording efficiency of a single pulse can be faithfully described by the formula:

1−d=b·exp(−C·W)+(1−b) (4),

where d is the modulation depth, W is the function corresponding to the extent of recording (or effect of recording), C is a normalizing constant, and b is the baseline, i.e. the maximal modulation depth in the specific recording mode. Hence, the function W corresponding to the effect of recording can be explicitly expressed from (4) as:

$$W = - ln ( 1 - \frac{d}{b} ) / C \qquad ( 5 )$$

In the specific set of measurements, the baseline b was chosen as 15% of modulation depth d, as the targeted power regimes for the envisioned embodiment are restricted by the existing power constraints to less than 15% modulation. It should be emphasized that modulation depths substantially higher than 15% have been achieved by repeated measurements, but current media do not target such modulation depths. As is shown, the exponential approximation enables showing that the effect of recording (relative recording) can be faithfully represented by a bi-variate monomial. It is clear that the methods disclosed are applicable to more complex cases and other measures of the medium sensitivity and mutatis mutandis the non-linearity of the carrier and of the reading and recording processes can be utilized in a similar way.

Another characteristic of the recording process is the so-called Relative Recording Efficiency (RRE), which is defined as Relative Recording (or recording efficiency that can be described by the function W divided by the Watt-Squared-Seconds. If the recording process is dependent only linearly on the extent of two photon absorption, then the RRE would have been constant for any pulse (regardless of the way recording efficiency is being quantified).

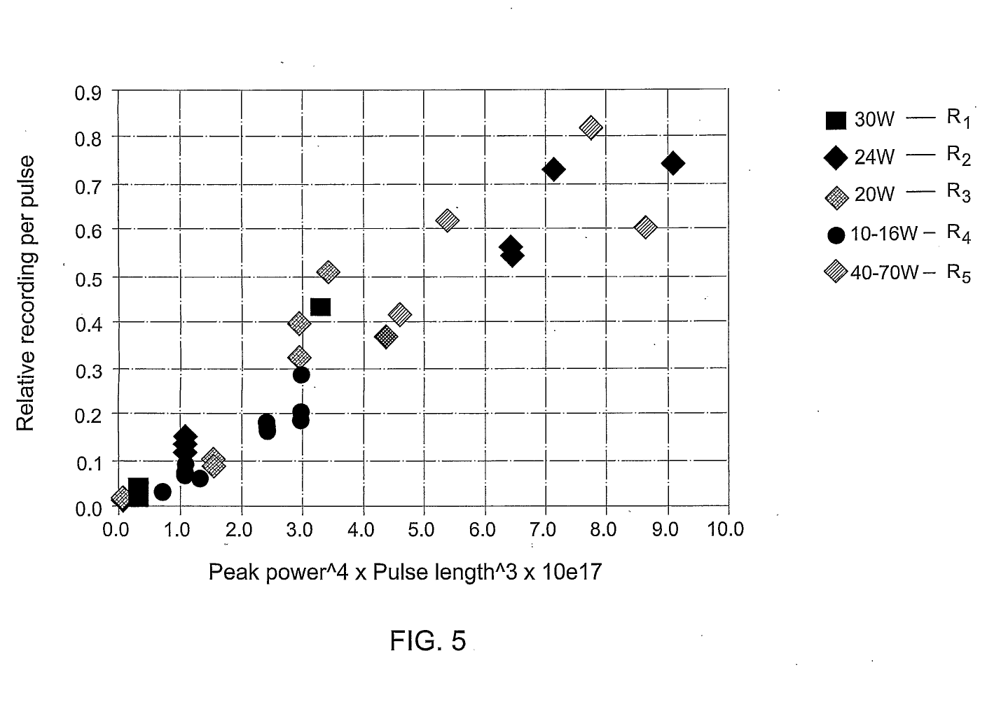

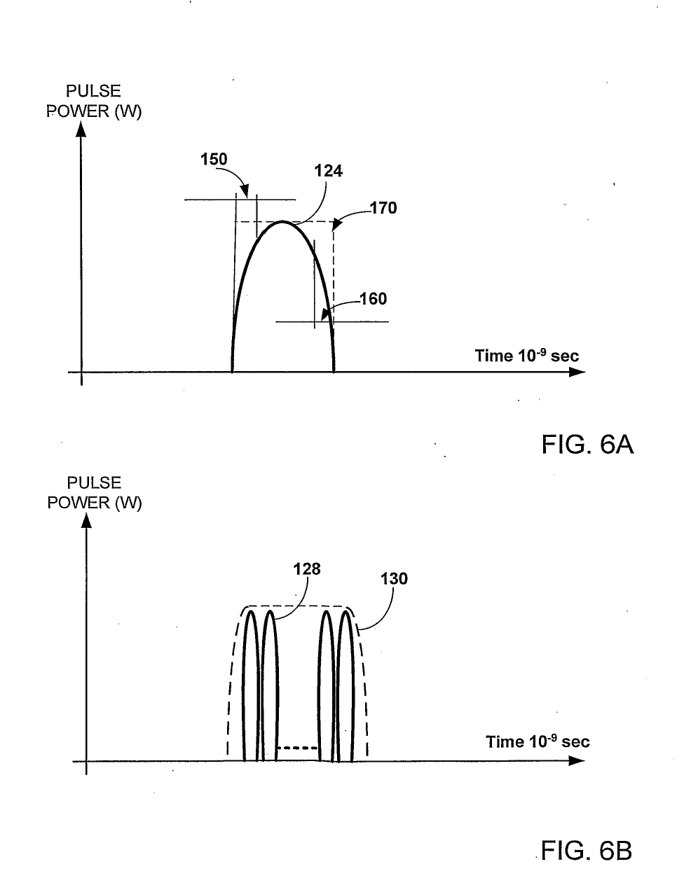

Reference is made to FIGS. 4 and 5, showing, respectively, RREs vs pulse length and recording efficiency per pulse as a function of product (PP⁴·PD³) where PP is the peak power and PD is the pulse length (duration), both for different values of the recording pulse power: R₁ corresponds to the 30 W peak power, R₂—to 24 W peak power, R₃—to 20 W peak power, R₄—to 10-16 W peak power, and R₅—to 40-70 W peak power.

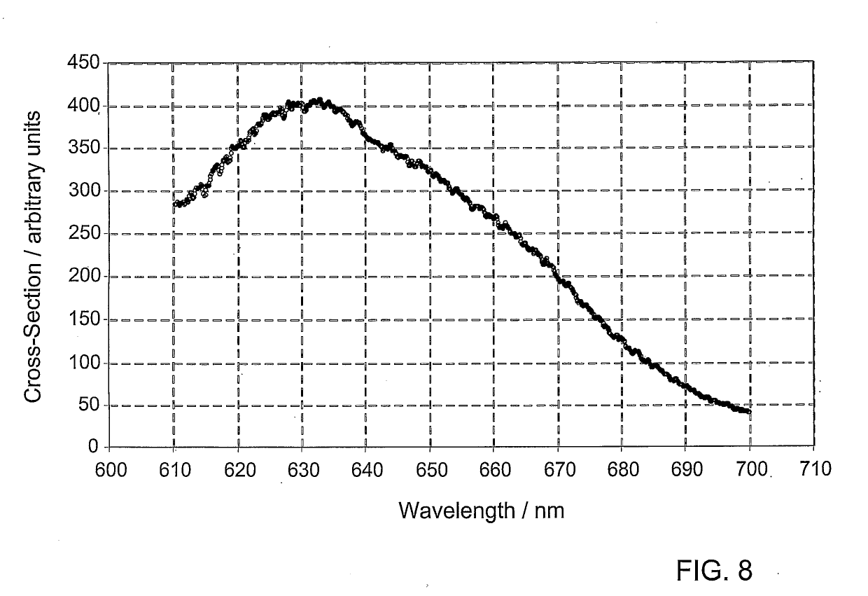

These data were obtained while applying measurements to the non-linear medium of the above described example. The measurements were performed with a solid state YAG pumped laser emitting coherent linearly polarized light pulses at 671 nm. Practically any laser in the red-NIR wavelength range would have performed with the same functional behavior as is shown by a two-photon absorbance spectrum of FIG. 8. The difference in the 2P cross-section would substantially change only the efficiency of the usage of the laser power as the medium is practically transparent (in terms of 1-photon absorption) in said wavelength range. The inventors also tested diodes in the 780-810 wavelength range in comparison to 658 nm diodes and found that the use of these diodes gives similar graying functional behavior but with a decreased absorbance cross section.

More specifically, FIG. 8 describes two-photon absorbance spectrum of the medium comprising eMMA produced in the above described procedure but with lower concentration (2%). A reference sample is placed in one cell, and the sample to be measured is placed in the second cell. A laser with variable wavelength (Continium Panther OPO pumped by Continium Surelite YAG) is scanned through the wavelength range and the signal from each cell is measured. For each point, the ratio of signals from the sample and reference is multiplied by the known cross-section of the reference and divided by a cell-to-cell calibration ratio. Finally it is normalized according to the differences in the concentrations to give the cross-section of the sample chromophore. TPDAS is chosen, with the 2-photon fluorescence excitation spectrum as disclosed in M. Rumi, J. E. Ehrlich, A. A. Heikal, J. W. Perry, S. Barlow, Z. Hu, D. McCord-Maughton, T. C. Parker, H. Rockel, S. Thayumanavan, S. R. Marder, D. Beljonne, J.-L. Bredas, /J. Am. Chem. Soc./*2000*, /122/,9500-9510.

Returning to the analysis of the power-time dependence measurements, in practice, as illustrated in FIG. 4, the Relative Recording Efficiency is not maintaining the above relation (i.e. constant RRE for any pulse). Obviously, high RRE characterizes a process having good recording properties. It should be understood that RRE is relative in the sense that it is compared to (P^{2·}t) (watt squared multiplied by pulse length) which is proportional to the absorbed irradiation in this case of two-photon process (as indicated by the signal power quadratic dependence).

As shown in FIG. 5 the graph of the recording efficiency per pulse as a function of product (PP⁴·PD³) is almost linear. This dependence allows for using a combination of different peak power and pulse length values that supports a variety of recording power optimization options. For example, the following peak powers and pulse durations are equivalent: (i) PP=p, PD=t, (ii) PP=2p, PD=t·2^{31 4/3}, (iii) PD=2t, PP=p·2^{-3/4}

Several processes may favorably affect the process of recording with “long” pulses. These processes include Accumulated Thermal Effect (ATE), Excited-State Absorption and Chromophore Cooperative Effects (Chromophore being an active component of the medium). The medium heats up during the pulse as a consequence of absorbing some of the laser radiation power. This temperature rise, in the center of the focused spot, is at least of the order of 10s of degrees higher than when recording is performed by a series of separated pulses, since in the interval between the pulses the heat dissipates.

The above indicated International patent applications PCT/IL2006/000050 and PCT/IL2006/000051, both assigned to the assignee of the present application, teach that heating can increase a recording speed by at least a factor of 2, possibly even by an order of magnitude. The excited state of the molecule might be able to absorb additional photons very efficiently. This additional energy could be involved by any of several mechanisms or a combination of them. For example, it could (i) increase the isomerization probability of the absorbing molecule, (ii) be transferred to the matrix, resulting in a larger temperature increase, or (iii) be transferred to a nearby neighbor by processes as an example of cooperative effects. The term “cooperative effect” refers to an effect by which a non-linear positive increase in writing (recording) sensitivity is enhanced inter alia by an increase of the concentration of the active chromophore. The use of very high concentrations of chromophores in a photochromic medium which may be part of a 3-dimensional (3D) optical memory may be advantageous for the data reading and writing characteristics of the medium. These advantages likely arise out of the higher number of active chromophores in the focus point from which signal is emitted and of the cooperative effects between neighboring photochromic groups. However, the increase in recording sensitivity requires control of the reading parameters so as to control the effect of graying. The action of one chromophore switching may cause a disturbance in the matrix that creates free space or stress near the neighboring chromophore when the concentration of the chromophore is high enough, thus increasing its chance of isomerizing. This effect may be non-linear, and for example it may become important only when already a significant amount of isomerization occurred.

All of the above leads to better quality of the recorded information where the better quality includes inter alia higher recording quantum yield, reduced graying level (during reading) and optimized media utilization. Comparing the effect of recording by a single “long” pulse (114 in FIG. 2A) with the effect of recording by a series of shorter pulses having similar peak powers and low duty cycle, recording by the single “long” pulse reduces the required amount of energy to be absorbed by the medium. This results in an increase of contrast (depth of modulation) that may reduce the reading energy and subsequently reduce the amount of graying during the reading process.

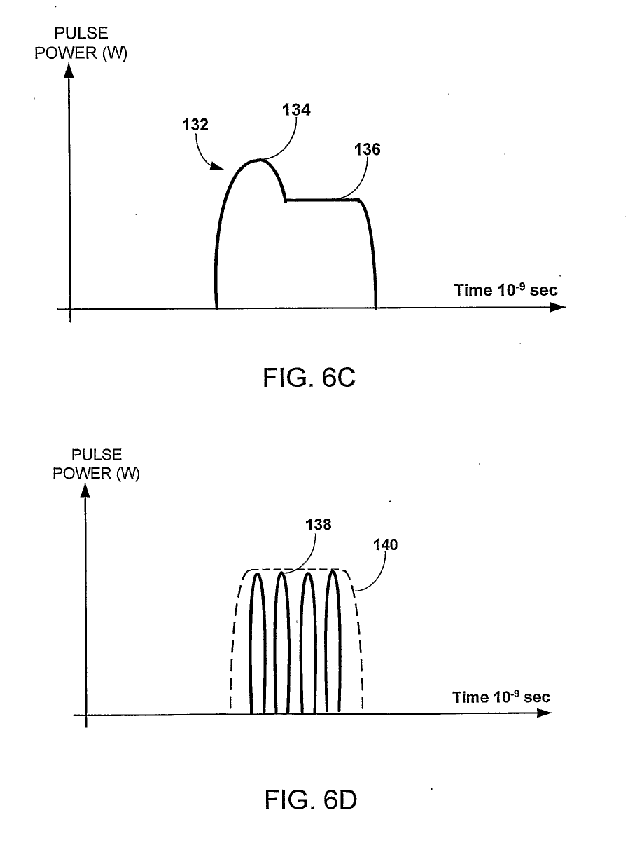

Reference is made to FIGS. 6A-6D illustrating different shapes (profiles) of the single long recording event. As indicated above the term “long event” used herein signifies an event of at least one nanosecond duration, for example about 5-150 nanoseconds.

FIG. 6A exemplifies the power profile (power vs time) for a single-pulse event. Here, numerals 150 and 160 mark respectively the pulse rise and the fall time, and numeral 170 marks the pulse envelop.

In another embodiment (FIG. 6B) a burst of few high-power packed sub-nano second pulses 128 with the duty cycle of about 30% replaces single pulse 124. The term “sub-nano” pulse means pulses with the duration up to about 1.5 nanoseconds. As indicated above, the burst parameters (individual pulse power and duration and a time interval between the pulses) are ensuring that the heat dissipation during the time interval between the pulses is insubstantial. Typically, the time interval between consecutive pulses within a burst is less than 10 nsec and is dependent on various parameters of the medium such as rotation speed, fluorescence life time, required temperature range and required modulation depth, which parameters may be coupled. When using an event in the form of a burst of short pulses, it is an advantage to statistically have all of the chromophores at least once in the excited state through the duration of the burst marked by envelope 130. To increase the number of repeated excitations of the chromophores, the time interval between the pulses is preferably of the order of the fluorescence life time.

In a further embodiment (FIG. 6C), the shape of the long recording pulse 132 is changed. Pulse 132, or the envelope of the pulse, has at least two parts with different power levels. Pulse 132 has a sharp rise time with the power increasing to an energy level 134 essentially higher than the rest of the pulse, where an energy level 136 (trailing part) is maintained to the end of the pulse. This excessive energy level 134 brings the medium to the correct recording temperature, where trailing part 136 of pulse 132 is more efficient in the actual recording.

In an additional embodiment (FIG. 6D), the single 40 nanosecond pulse is replaced by a burst of four pulses, each of about 10 nanosecond duration. The burst envelope 140 is slightly longer than the 40 nanosecond pulse.

Pulse shaping can positively influence such processes as local heating, excited state absorption (“Two-photon Excitation and Optical Spatial-Profile Reshaping via a Nonlinear Absorbing Medium” by Guang He et al., Journal of Phys. Chem. A 2000, 104, pp 4805-4810.), fluorescence quantum yield, excitation of the excited state to elevated states with higher quantum yields for recording and re-excitation of the active chromophores.

To simplify the system, it is preferable that the same radiation wavelength range is used for both the data recording and the data retrieving. The same radiation wavelength range may be obtained from a single (one) laser source. Commercially existing laser diodes may be used at peak powers ranging up to tens of watts. Data reading at data rates higher that 1 Mbps typically requires nanosecond pulses having peak power in excess of 0.05 W, data recording at similar data rates requires long pulses having peak power higher than 0.5 W.

It is possible to generate different pulse shapes and different power levels so that recording during the reading process (graying) will be reduced below the threshold value. This type of optimization may be achieved by utilizing the non-degenerate relation between the functions corresponding to the recording and reading effects in the reading process. If at least one of these conditions is met, there will be produced recording and reading conditions allowing an increased number of reading cycles with limited recording.

As indicated above, the medium response to recording follows a different polynomial function (P⁴·t³) than the reading response (P²·t). Both processes can be characterized by a non-linear dependence on the pulse shape, duration and energy flux of the recording beam and a non-linear response to the pulse shape, duration and energy flux of the reading beam, and in specific cases, by the difference in the powers of the dominant polynomial coefficients. The lowest acceptable reading beam energy flux and pulse shape combinations (in a certain power range) may be determined by a reliably readable signal, and the highest allowable value of graying by the reading beam (as a function of the energy flux and pulse shape and other parameters) may be bound according to system requirements (e.g. number of reading cycle at specific SNR range). The reliable mark modulation depth typically means a modulation depth higher than 1%, more typically 10-20%, rarely less than 1% or more than 20%. The required recording beam pulse shape, duration and energy flux may be expressed as described above by a non-linear function.

Utilization of these functional differences (non degenerate relation) for example as approximated by dependence on the polynomial powers supports design of data recording and data reading strategies enabling graying control. When the functional bounds are not polynomial, they can be approximated as such to the required accuracy, and the difference between the processes can be maintained or bounded by another convenient functional form to provide bounds for design of a safe working regime.

An exemplary method of optimizing the reading and recording strategies to control the extent of graying is now provided. For example, a safe functional form of recording process is bounded from below (lower bound). For the estimate of the extent of graying due to reading of data recorded by a given recording strategy, the functional form of recording process should be bounded from above (upper bound) during the reading process. For each feasible recording and reading strategy the amount of recording during reading and recording is conservatively estimated by the ratio between these bounds. A numerical example using functional estimates instead of upper and lower bounds is given further below.

The practical use of the functional form of the lower bound on the recording efficiency of the recording process and the upper bound of the recording during the reading process is performed by selection of reading parameters that will induce recording which is less than the recording induced by the recording process by a certain predetermined ratio as determined by said bounds. A numerical example is provided for the sake of clarification and practical implementation; using the P⁴t³ functional form for both the lower bound of the recording during the recording event and the upper bound of the recording during the reading event.

It is typically required that the number of allowable reading cycles (repeating the reading event on the same recorded region/mark) would not cause substantial change in the contrast, e.g. that the recording by the reading cycles would not change the modulation depth e.g. by more than 20% and more preferably more than 5% of the modulation depth (i.e. from 0.1 to 0.08 and more preferably 0.1 to 0.095). It is important to note that shortening the pulse (event duration) e.g. by a factor of 5 and increasing the power by a factor of \sqrt{5} (from 300 mW, 5 nsec to 1 nsec 670 mW) would provide the same reading efficiency but the graying (recording) extent is reduced.

Short pulses such as pico second pulses with duty cycle of about 1% can be provided for example by High Power Picosecond Diode Laser PicoTA, commercially available from PicoQuant GmbH, Berlin, 12489 Germany. The low duty cycle is required to minimize the number of pulses irradiating the same location in a rotating disk.

Israeli patent application No. 167,262, assigned to the assignee of the present application, discloses a laser diode driver suitable for driving a laser diode with sub-nanosecond pulses and is incorporated herein by reference. Alternatively, self pulsating laser diodes such as model SLD 1134VL, commercially available from Sony Corporation, Tokyo Japan may be used for reading. Use of self pulsating laser diodes, operating in the pico seconds pulse range, may be beneficial for reading from the energy consumption point also. Femto second laser pulses reduce or even eliminate local heating of medium, shorten the time of the unwanted destructive reading process and prevent the associated undesired recording.

As indicated above, coherence and polarization of the irradiating beam may also affect the relation between the functions corresponding to the medium response to reading radiation and to the effect of recording in the medium. A non linear medium, such as medium comprising chromophores susceptible to 2P absorption, is sensitive to the polarization of irradiating light because of the anisotropy of the respective interaction, thus molecular freedom and orientation of the chromophores in the matrix play an important role in the response of the medium to either reading or recording radiation and may thus affect graying. Manufacturing processes of polymers play an important role in the orientation of the matrix and chromophores and other composites of the medium. The effect of polarization was demonstrated by showing that recording to achieve a certain modulation depth under the same conditions but different polarizations is obtained at different rates that may vary by more than 20%. The combined effect of coherence and polarization was shown by focusing light beams of complementing polarization emitted by two diodes through a polarizing beam splitter/combiner into overlapping diffraction limited focused spots, and it was found that for this setup signal emanating from the storage medium (directly proportional to absorption) was less than quadratic in terms of peak power dependence. When power was increased by a factor of 2, the signal emanating from the medium increased only by a factor varying between 2.5 to 3 (instead of 4). The variation is attributed to leakage between the diodes which in turn affects the mutual coherence between the diodes. When the light beams from two diodes are completely incoherent, e.g. pulsating in non-intersecting time intervals, the increase in signal would be only linear, i.e. the emanating signal would increase only by a factor of two. The described effect cannot be attributed to either polarization or coherence alone. Proper choice of coherence and polarization of the exciting radiation for the reading process should preferably be considered for the control of graying because it changes the relation between the effect of reading (medium response) and the effect of graying or recording (even by changing only one of the processes).

The importance of the conditions of the reading pulse (coherence and polarization) can be understood noting that lower effectiveness for reading affects the system by requiring longer irradiation period for the same required amount of signal and thus reduces the ability to control graying.

Thus, the effect of graying can be reduced by proper selection and control of the recording and reading radiation parameters that include radiation power, pulse shape and power application duration, selected for a certain condition of radiation wavelength, coherence and/or polarization. It is also possible to reduce graying by appropriate selection of the chemical composition of the medium.

US Patent Publication US2005254319 and co-pending U.S. patent application Ser. No. 11/285,210, both assigned to the assignee of the present application, teach methods of optimization of a two photon medium for recording and reading purposes. The above indicated Patent Cooperation Treaty Application PCT/IL2006/00051, assigned to the assignee of the present application, teaches that control of the concentration and composition of the medium has an effect on the extent of graying. The present invention may utilize the techniques and media described in these patent applications to improve the reading process with controlled graying that provide a reliable non-linear optical memory.

While the exemplary embodiment of the present method have been illustrated and described, it will be appreciated that various changes can be made therein without affecting the spirit and scope of the method. The scope of the method, therefore, is defined by reference to the following claims:

1. A method for use in at least a process of reading data in a non-linear optical storage medium, the method comprising: utilizing a first mathematical function corresponding to an effect of data recording in the medium used and a second mathematical function corresponding to an effect of reading the recorded data, each of the first and second functions being a function of at least a power profile of applied interacting radiation in a respective one of the recording and reading events and a duration of said event, and selecting a certain operating mode defined by ranges of said power and duration during the reading process corresponding to a non-degenerate relation between said first and second functions.

2. The method of claim 1, comprising appropriately varying at least one of the power and duration parameters to control an effect of recording during the reading process.

3. The method of claim 1, wherein said operating regime is selected for a given conditions of at least one of the following parameters: wavelength, coherence and polarization of the applied interacting radiation.

4. The method of claim 1, utilizing said non-degenerate relation to provide a predetermined ratio between the maximal allowed effect of data recording during the reading event to an effect of recording achieved while recording the data being read.

5. The method of claim 4, wherein said ratio is non-degenerate such that at least one of the power and duration parameter is used as a free parameter to control said effect of recording during the reading event, sensitivity of said at least one parameter in terms of functional dependence being higher than the square root of said parameter.

6. The method of claim 1, comprising selecting a function corresponding to the power profile during the reading event.

7. The method of claim 1, comprising performing the reading and recording using the same wavelength range of the interacting radiation.

8. The method of claim 7, comprising generating the first interacting radiation for the reading process and the second interacting radiation for the recording process in a red-NIR spectrum.

9. The method of claim 7, wherein said wavelength range is about 600-800 nm.

10. The method claim 1, wherein a response signal of the medium defining the effect of reading is in a range of 400-600 nm.

11. The method of claim 1, wherein wavelengths of the recording and reading interacting radiations differ from each other by a value substantially not exceeding 300 nm.

12. The method of claim 1, wherein the duration of at least one of the reading and recording events is at least one nanosecond.

13. The method of claim 12, wherein said recording event is represented by a single pulse.

14. The method of claim 12, wherein said recording event is represented by a burst of pulses, an envelope of the burst being of at least one nanosecond duration.

15. The method of claim 1, wherein the energy of the interacting radiation during the recording is at least two times higher than the energy of the interacting radiation during the reading event.

16. The method of claim 1, wherein said first and second functions are respectively: W=C₁·P^{m1}·tⁿ¹ and S=C₂·P^{m2}·tⁿ², wherein P is peak power, t is event duration, C₁ and C₂ are certain coefficients, m₁, n₁, m₂ and n₂ are dominant powers selected to satisfy a condition that m₁/m₂≠n₁/n₂.

17. The method of claim 16, wherein said first and second functions are W=C₁·P^{1.5}·t^{2.5} and S=C₂·P^{1.5} ·t.

18. The method of claim 17, wherein the controlling of the effect of recording during the reading process comprises selecting the duration of the reading event.

19. The method of claim 16, wherein said first and second functions are W=C₁·P⁴·t³ and S=C₂·P²·t.

20. The method of claim 19, wherein the controlling of the effect of recording during the reading process comprises selecting at least one of the power and duration of the reading event.

21. An information carrier comprising a non-linear optical storage medium selected for use in the method of any one of preceding claims, the non-linear optical storage medium being selected to be characterized by a first mathematical function corresponding to an effect of data recording in the medium and a second mathematical function corresponding to an effect of reading the recorded data, where each of the first and second functions is a function of at least a power profile of applied interacting radiation during the respective one of the recording and reading events and a duration of the respective event, such that there exist certain ranges of said parameters for the reading process corresponding to a non-degenerate relation between said first and second functions.

22. An illumination system for producing predetermined interacting radiation for use in at least one of data reading and recording processes on a non-linear optical storage medium, the system comprising:
(a) a light source unit configured for generating interacting radiation; and
(b) a control unit for operating the light source unit with selected values of a power profile of the interacting radiation during at least one of the reading and recording events and a duration of the respective event, to thereby produce said predetermined interacting radiation, said values being within ranges providing sufficient reading and recording and corresponding to a non-degenerate relation between a first mathematical function corresponding to an effect of recording in the medium used and a second mathematical function corresponding to said medium response to a reading signal, each of the first and second functions being a function of the power of exposure and the duration of the respective one of the recording and reading events
the system thereby enabling controlling of the effect of recording during the reading process.

23. The system of claim 22, wherein the control unit is configured to operate the light source unit to generate the first and second interacting radiations of the same wavelength range.

24. The system of claim 22, wherein the control unit is configured for operating the light source unit to generate the interacting reading and recording radiations of wavelengths different from each other by a value substantially not exceeding 300 nm.

25. The system of claim 22, wherein the light source unit is configured to generating the interacting radiation in a red-NIR spectral range.

26. A system for performing at least one of reading and recording of optically storable information, the system comprising:
(a) an optical information carrier formed by a non-linear optical storage medium configured to be characterized by a first mathematical function corresponding to an effect of recording therein and a second mathematical function corresponding to an effect of reading the recorded data, each of the first and second functions being a function of at least a power profile of applied interacting radiation during the respective one of the recording and reading events and a duration of said event, such that there exist values of the power and duration for the reading process within ranges corresponding to a non-degenerate relation between said first and second functions
(b) an illumination system comprising a light source unit configured and operable for generating interacting radiation for at least one of the reading and recording processes using said values of the power and duration.

27. An optical memory reading device comprising:
(a) a light source unit configured for generating interacting radiation to be applied to a non-linear optical medium to cause a readable light response therefrom; and
(b) a driver for operating the light source unit with selected values of a power of the interacting radiation during a reading event and a duration of the respective event, said values being within ranges corresponding to a non-degenerate relation between a first mathematical function corresponding to an effect of recording in the medium used and a second mathematical function corresponding to an effect of data reading, each of the first and second functions being a function of at least the power of the interacting radiation and the duration of the respective one of the recording and reading events.
